(19) United States
(12) Patent Application Publication
(10) Pub. No.: US 2016/0091444 A1
(43) Pub. Date: Mar. 31, 2016

(54) STAY CABLE ASSESSMENT

(71) Applicant: NATIONAL ICT AUSTRALIA LIMITED, Eveleigh, New South Wales (AU)

(72) Inventors: Rodney BERRIMAN, Eveleigh, NSW (AU); Maximilian OTT, Eveleigh, NSW (AU); Peter RUNCIE, Eveleigh, NSW (AU); Matthias LEITNER, Eveleigh, NSW (AU); Philipp MAYR, Eveleigh, NSW (AU)

(21) Appl. No.: 14/892,165

(22) PCT Filed: Jun. 11, 2014
(86) PCT No.: PCT/AU2014/050069

§ 371 Date: Nov. 18, 2015

(30) Foreign Application Priority Data
Jun. 4, 2013 (AU) 2013902003

(51) Int. Cl. G01N 27/00

(52) U.S. Cl. CPC G01N 27/00

(57) ABSTRACT

The disclosure concerns monitoring cables, such as stay cables used to support bridges. A cable comprises multiple strands which are electrically connected to each other at one or both ends of the cable and insulated from each other between the ends. A cable monitor selectively activates one or more inductive coils, such that electrical signals are 5 suppressed on a first set of the multiple strands and electrical signals are allowed to pass through a second set of the multiple strands. The monitor then applies an electrical stimulus signal to the cable and senses on the cable a reflection signal of the stimulus signal. Finally, the monitor determines based on the reflection signal a continuity of one or more of the second set of the multiple strands. Since reflections 10 are suppressed on some strands by the coils, the sensed reflections can be attributed to the strands without the suppression.

### CROSS-REFERENCE TO RELATED APPLICATIONS

The present application claims priority from Australian Provisional Patent Application No 2013902003 filed on 4 Jun. 2013, the content of which is incorporated herein by reference.

### TECHNICAL FIELD

The disclosure concerns monitoring cables, such as stay cables used to support bridges.

### BACKGROUND ART

Cables are used widely to support various loads, such as in cable stay bridges or cable as Many of these applications are intended to last for decades but the integrity of the cables cannot always be guaranteed for such a long time. As a result, it is important to assess the integrity of the cables to prevent premature failure.

FIG. 1a illustrates a cable stay bridge 100, such as the Anzac Bridge in Sydney, Australia. The bridge 100 comprises a bridge deck 102 on which traffic crosses the bridge 100. The bridge 100 further comprises two pylons 104 and 106 and multiple stay cables, such as exemplary stay cable 108. The Anzac Bridge, for example, comprises 128 stay cables.

FIG. 1b illustrates stay cable 108 in more detail. Stay cable 108 comprises 7 strands, such as strand 110. and each strand comprises five wires, such as wire 112. In the example of the Anzac Bridge, each cable comprises 25 to 75 strands and each strand comprises 7 wires. While the wires 112 are in electrical contact to each other along the entire length of the cable 106, the strands 110 are insulated from each other along the length of the cable 106.

The strands 110 are mechanically secured at both ends of the cable 108 by a clamping mechanism (not shown) to provide a firm mechanical connection between the wires of the cable 108, the top of the pylon 104 and the bridge dock 102. As a result, mechanical loads from the bridge deck 102 are transferred via the stay cable 108 to the pylon 104.

As a side effect, the clamping mechanism electrically connects all strands 110 of the cable and therefore forces the ends of the strands 110 to the same electrical potential or voltage. As a result, it is difficult to measure the strands 110 individually to determine faulty strands although it would be possible to replace an individual faulty strand of cable 108.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or steps or group of elements, integers or steps.

### DISCLOSURE OF INVENTION

In a first aspect, there is presided a method for monitoring a cable comprising multiple strands which are electrically connected to each other at one or both ends of the cable and insulated from each other between the ends, the method comprising:
selectively activating, one or more inductive coils, such that electrical signals are suppressed on a first set of the multiple strands and electrical signals at allowed to pass through a second set of the multiple strands;
applying an electrical stimulus signal to the cable;
sensing en the cable a reflection signal of the stimulus signal; and
determining based on the reflection signal a continuity of one or more of the second set of the multiple strands.

It is an advantage that inductive coils are activated to suppress electrical signals on selected strands. As a result, reflections that would otherwise arrive at a sensing location from the selected coils are suppressed and the sensed reflections can be attributed to the strands without the suppression.

The first set may comprise all but one test strand of the multiple strands and the second set comprises the test strand.

It is an advantage that only one test strand has no suppression. As a result, it is possible to determine the continuity of that test strand individually.

The electrical stimulus signal may be an electrical pulse.

It is an advantage that the stimulus signal is an electrical pulse, since a pulse propagates through the cable and is reflected from. discontinuities and the ends of the cable. As a result, the continuity of the cable can be measured by sensing the reflected pulse at a convenient position of the cable and the cable does not need to he accessed over the entire length, such as when visually inspecting the cable.

The length in time of the pulse may he short compared to the propagation time of the pulse along the cable.

Sensing a reflection signal may comprise determining one or more arrival times of one or more pulses of the reflection signal and determining a continuity may be based on the one or more arrival times.

Determining a continuity may comprise comparing the one or more determined arrival times to one or More expected arrival times

The method may further comprise determining that the continuity is below a damage threshold if one of the one or more determined arrival times is earlier than n of the one or more expected arrival times.

Determining one or inure arrival times may comprise identifying one or more pulses reflected from a discontinuity.

The method may further comprise if the determined continuity is below a damage threshold repeating the method for multiple different combinations of strands in the first set and second set, such that the multiple sensed reflection signals allow the identification of exactly one strand that has the continuity below the damage threshold.

It is an advantage that the method is repeated for different combinations of strands such that the strand with the continuity below the damage threshold can be identified. As a result, the method does not only provide detection of a damage in the cable but also the determination of the damaged strand. The damaged strand can then be replaced without replacing the entire cable.

The first set may have all but two of the multiple strands and the second set may have the two of the multiple strands.

The electrical stimulus signal may he an electrical pulse and wherein determining a continuity may comprise:
determining a count of one or more reflected pulses; and
determining that the continuity is below a damage threshold if the count of the one or more reflected pulses is greater than one.

It is an advantage that when two strands carry the signal, sensing the reflection signal can detect an earlier reflection signal from one strand and a later reflection signal from the other strand. As a result, the accuracy of the method is enhanced since only the count of detected arrival times needs to be determined instead of the arrival time.

The method may further comprise transforming the sensed reflection signal into a frequency representation, wherein determining the continuity is based on the frequency representation of the reflection signal.

Determining the continuity may comprise comparing the frequency representation of the reflected signal to an expected frequency representation.

In a second aspect there is provided a system for monitoring a cable comprising multiple strands which are electrically connected to each other at one or both ends of the cable and insulated from each other between the ends, the system comprising:
multiple coils to selectively suppress electrical signals on a first set of the multiple strands and allow electrical signals to pass through on a second set of the multiple strands;
a signal generator to apply an electrical stimulus signal to the cable;
a sensor to sense a reflection signal of the stimulus signal; and
a processor to determine based on the reflection signal a continuity of one or more of the second set of the multiple strands.

Optional features described of any aspect, where appropriate, similarly apply to the other aspects also described here.

### BRIEF DESCRIPTION OF DRAWINGS

FIG. 1a illustrates a cable stay bridge.

FIG. 1b illustrates a stay cable in more detail.

An example will he described with reference to

FIG. 2 schematically illustrates a system for monitoring cable.

FIG. 3a illustrates an example of a faulty cable.

FIG. 3b illustrates a sensed reflection signal.

FIG. 4 illustrates sensed reflection signals for different combinations of activated coils.

FIG. 5 illustrates a method for monitoring a cable.

### BEST MODE FOR CARRYING OUT THE INVENTION

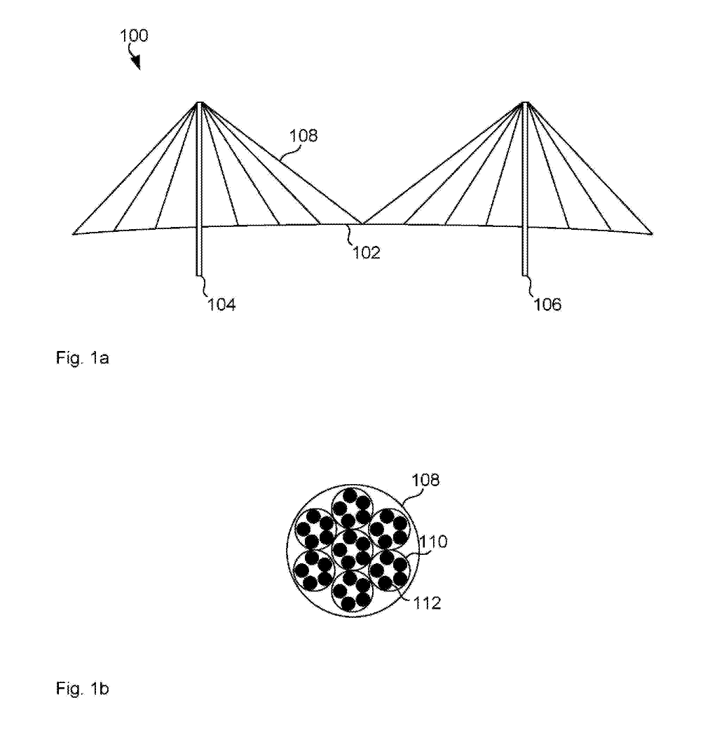

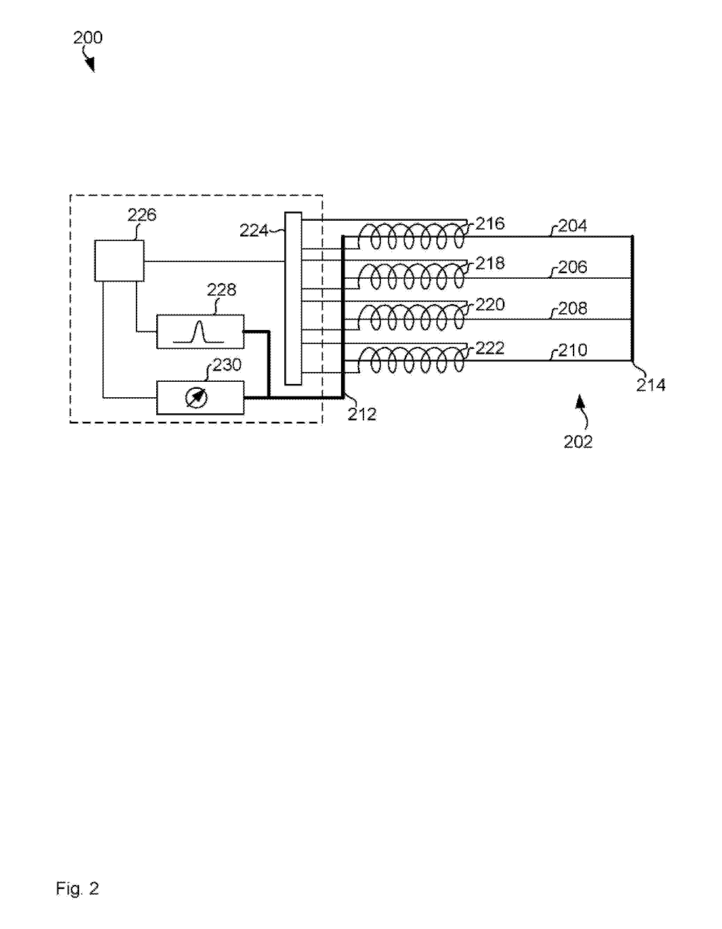

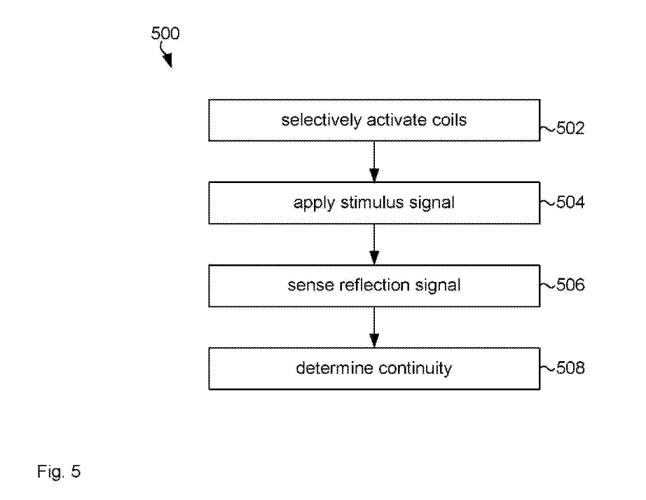

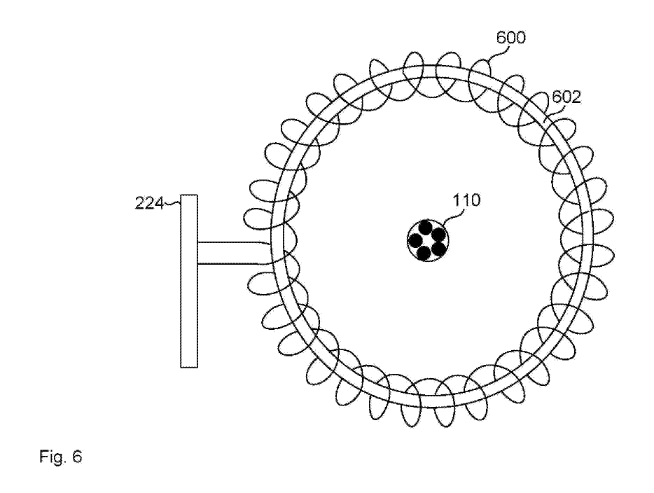

FIG. 2 schematically illustrates a system 200 for monitoring a cable 202. The monitoring system 200 performs a method for monitoring a cable as described with reference to FIG. 5. Similar to cable 108 in FIGS. 1a and 1b cable 202 comprises four strands 204, 206, 208 and 210. The four strands 204, 206, 208 and 210 are electrically connected to each other by a first clamping system 212, which connects the cable 202 to the bridge deck 102 at the lower end of the cable 202. Further, the four strands 204, 206, 208 and 210 are electrically connected by a second clamping system 214, which connects the cable 202 to the pylon 104 at the upper end of the cable.

The first clamping system 212 and the second clamping system 214 force the ends of the four strands 204, 206, 208 and 210 to a common electrical potential. As a result, applying a constant voltage to each strand individually and measuring the current to measure conductivity and therefore integrity of each strand is not possible. As long as there is one single intact strand in the cable, measuring the conductivity of the cable would indicate an intact cable even if all other strands are broken.

The monitoring system 200 comprises multiple coils 216, 218, 220 and 222 connected to a selection circuit 224. The selection circuit 224 may take a variety of different forms, such as a separate switch for each of the coils 216, 218, 220 and 222 to shorten the respective coil and connect it to ground potential.

In one example, each strand is equipped with inductive coils made of copper wire. The coils are installed in a way that they surround each strand with a thin layer of insulating material between coil and strand. Coils would typically be surrounded by insulating material to prevent electricity flowing to and from other coils and strands.

Each coil is connected at both ends to an electrical grounding point to which the strand is also connected. An example is a cable anchorage or cable end cap. The connections are equipped with a switch to allow the circuit to be opened or closed. Typically this would be controlled by an electronic controller but could be as simple as a simple physical switch. The important point is that the coil is short circuited, not that it is grounded. When it is short circuited, the coil has a high inductance, which suppresses high frequency components in signals passing through the strand.

Example construction: Enamelled copper wire on a thin cylinder made on strong insulating material such as nylon, 25 mm outer dimension, tightly fitting on the stand of about 17 mm diameter. Length of coil 100 mm with 100 windings.

The switch may he a mechanical switch, such as a relay, or a solid state switch, such as a transistor. In other examples, the selection circuit applies a signal to the coils 216, 218, 220, 222. The selection circuit 224 is connected to a processor 226 and receives commands from the processor 226 including coil identifiers. The coil identifiers define which of the coils 216, 218, 220, 222 are activated. In one example, this means that the activated coils are shortened and connected to ground potential.

As a result of selecting and activating the coils, electrical signals, such as transient signals and pulses, are suppressed on a first set of the strands 204, 206, 208 and 210 and allowed to pass through on a second set of multiple the strands. In one example, strand 204 is to be tested and is the only strand in the second set of strands. Strand 204 is therefore referred to as the test strand. In order to suppress signals on the strands in the first set, that is strands 206, 208 and 210, the respective cods 218, 220 and 222 are activated. Once the testing of test strand 204 is completed as described below, the same method may be repeated for the remaining strands 206, 208 and 210.

The first clamping system 212 is connected to a signal generator 228, such as a Time-domain reflectometer, and a sensor 230. The signal generator 228 applies an electrical stimulus signal to the cable 202 via clamping system 212. It is noted that the electrical stimulus signal may also he applied to one of the strands 204, 206, 208 or 210 as long as it is applied sufficiently close to the end of the cable, such as the clamping system 212. In one example, the electrical stimulus signal is applied within 1 m from the end of the cable 202.

In one example, the electrical stimulus signal is an electrical pulse with a pulse duration of 1 ns and a peak voltage of 50V. Other parameters for the pulse are of course possible as long as the pulse is short compared to the propagation time of the signal to the fault location. Unfortunately, the fault could be located in the first few metres, which is why ins is a good figure to choose. The peak voltage may be chosen so as to not present a shock hazard in case anyone comes into contact with the impulse.

After the signal is applied to the cable 202, the signal propagates along the cable 202 through strands with coils that are not activated to suppress transient signals. The signal is reflected at the end of the cable 214 and returns along the same strands to the clamping system 212.

Sensor 230 senses this reflection signal of the stimulus signal. In one example, the sensor 230 has a timer and a voltage threshold. Each time the voltage at the end of the cable 202 crosses the voltage threshold from low to high, the sensor 230 records the current time from the timer as the arrival time of a pulse. In some examples, the sensor 230 is integrated with the processor 226 into a microcontroller with an integrated A/D converter and the voltage threshold is represented by a binary value stored in a program memory of the microcontroller.

The processor 226 receives the arrival time and determines based on the arrival time, which is in turn based on the reflection signal, a continuity of the strands which have their respective coils not activated to suppress transient signals.

In case of a perfectly continuous cable, the pulse propagates equally along the non-suppressed strands, is reflected at the end 214 of the cable and returns as a single pulse at the clamping system 212. However, over time the total cross sectional area of the wires decreases and discontinuities appear, such as broken wires.

Determining a continuity means to determine to which degree the cable is continuous or whether there are discontinuities. For example, the result of determining a continuity may be “essentially continuous” in case of a non-faulty cable or “unsafe discontinuities” in case of a cable where the number of intact wires in the cable is below a specified threshold. A number value may also be assigned to the continuity, such that 1 indicates a continuous cable and 0 indicates a broken cable. Values between 1 and 0 may indicated various degrees of discontinuities. A damage threshold may be defined such that a strand is considered faulty if the continuity is below the damage threshold.

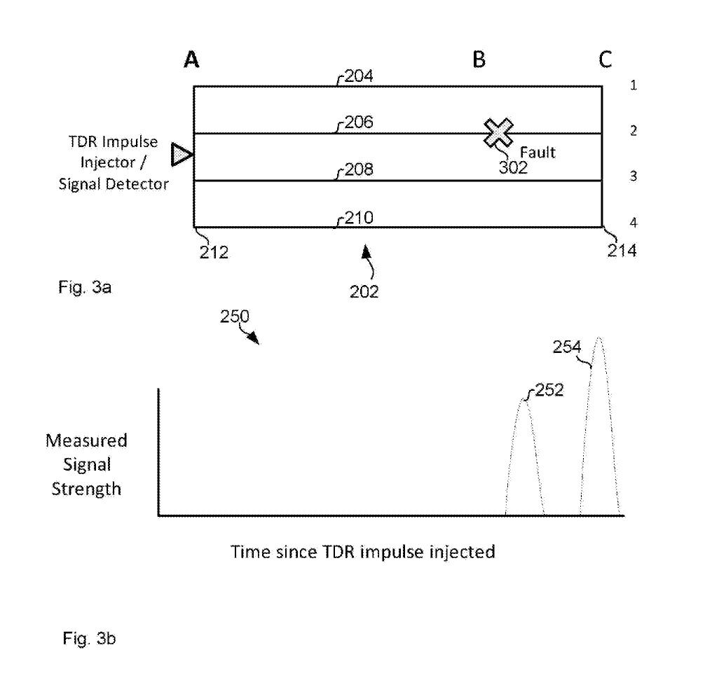

FIG. 3a illustrates an example where cable 202 has one faulty strand 206 and three intact strands 204, 208 and 210. Faulty means that the diameter of at least one wire. of strand 206 is significantly reduced or broken such that the pulse applied to the cable is at least partially reflected from that fault. In the example of FIG. 3b strand 206 has a fault 302 in position B. The pulse is applied to one end 212 of cable 202, reflected by the fault 302 and the other end 214 and is sensed at the first end 212. Since signals are not suppressed on any of the strands 204, 206, 208 and 210, the pulse propagates through all strands 204, 206, 208 and 210.

FIG. 3b illustrates the sensed reflection signal 250. Since the signal is reflected from the fault 302 as well as the distal end 214, the reflection signal comprises a first reflection puke 252 caused by the fault and a second reflection pulse 254 caused by the end 214. Sensing the two distinct reflection signals 252 and 254 causes the processor to determine a continuity that is not sufficient for safe operation of the bridge.

Determining that one of the strands is faulty is also referred to as detecting a faulty strand. However it is also necessary to identify exactly which of the strands is faulty in order to replace the faulty strand and restore the integrity of the bridge. The procedure of FIGS. 3a and 3b does not allow the identification of the faulty strand. in order to identify the faulty strand 206 the coils in FIG. 2, which are not shown in FIG. 3a, are selectively activated to suppress transient signals. In a first iteration, coils 218, 220 and 222, that is all coils except the top coil 216 are activated such that signals are suppressed on strands 206, 208 and 210, that is all strands except the top strand 204. Since signals on the faulty strand 206 are suppressed the reflection signal comprises only the later pulse 254 from the distal end 214 of the cable 202.

The same measurement is repeated while the signals on all strands except strand 206 are suppressed. As a result, the reflection signal comprises only earlier pulse 252. Since the arrival time of the pulse 252 on strand 206 is earlier than the arrival time 254 of strand 204, the processor 226 determines the continuity of strand 206 as being below a damage threshold and therefore, identifies strand 206 as the faulty strand. Strand 206 can then be replaced to restore the overall integrity of the bridge.

In this example, the arrival times of different strands are compared to each other to identify a strand with an early arrival time. In other examples, the arrival time of a continuous strand is known and the arrival times of the individual strands are compared to the known arrival time to determine an early arrival time. This way, the processor 226 identifies the pulses which are reflected from a discontinuity, such as a fault, as opposed to pulses reflected from the end 214 of the cable 202. If a pulse reflected from a fault is detected, the strand is considered faulty. In a different example, the processor 226 simply counts the number of pulses and determines that the strand is faulty if more than one pulse is counted.

It is noted that the use of the arrival times requires exact time keeping and therefore, expensive electronic equipment. However, the above method can be modified as described below to identify the faulty strand by merely counting the number of pulses for different combination of strands and without the need for accurate time keeping.

For the example of FIGS. 2 and 3a with four strands 204, 206, 208 and 210, six separate measurements or tests are performed sequentially, where ‘on’ means that the respective coil is activated to suppress transient signals:

Test 1: all coils on except 204 and 206

Test 2: all coils on except 204 and 208

Test 3: all coils on except 204 and 210

Test 4: all coils on except 206 and 208

Test 5: all coils on except 206 and 210

Test 6: all coils, on except 208 and 210

There are correspondingly more tests for cables with more than four strands.

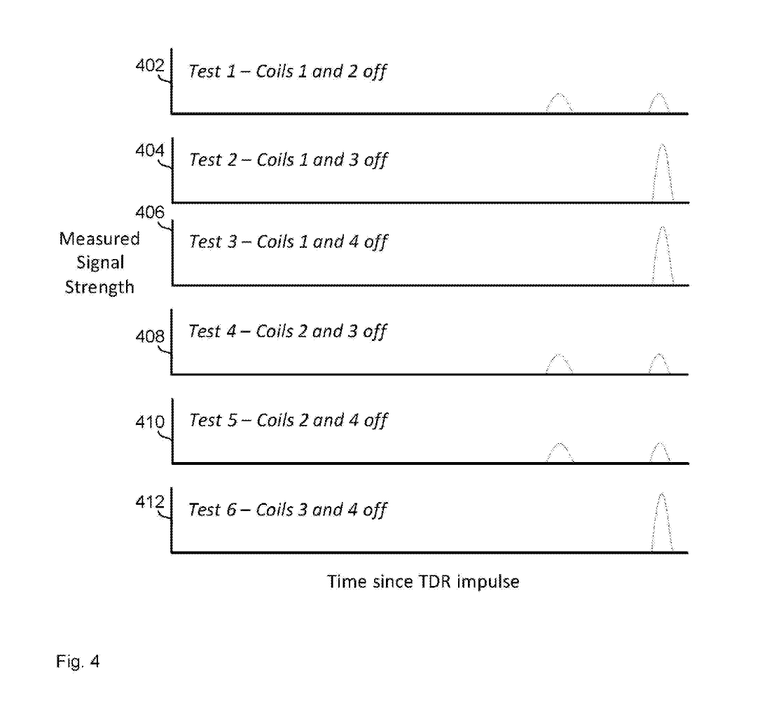

FIG. 4 shows the sensed reflection signals 402, 404, 406, 408, 410 and 412 for the six different tests, respectively. The first test 402, the fourth test 408 and the fifth test 410 each show two pulses sensed by the sensor. This indicates that all these tests comprise a faulty strand and that for these tests the transient signal on the faulty strand was not suppressed. The other tests show only a single pulse and therefore do not include the faulty strand. Since the only strand that is in common to the tests with two pulses is the second strand 206, the processor 226 determines that the second strand 206 is the faulty strand, that is, the continuity of the second strand 206 is insufficient.

This way, an inexpensive, detection of pulses is required rather than an accurate timing of each pulse. However, the entire process needs to be repeated for all combinations of strands, which could potentially be a large number. Since each test can be completed in a short time, such as 300 ns propagation time plus processing time, even in case of 50 strands where 1225 different pairs need to be tested, the entire process should be completed within 1 second.

In another example, the measurements for all pairings are compared to identify measurements which are unusual compared to the broader population of measurements. If a strand is damaged then it would be expected that all measurements involving that strand show unusual characteristics. Various data analysis techniques can be used to identify unusual measurements. These techniques could include supervised or unsupervised machine learning techniques for example. Measurements are kept for future reference. If measurements are retaken at a later date and a strand has experienced damage in that time the resulting change in measurements will be apparent. That is, the processor 226 compares the reflected signal for each strand to a previously stored signal and determines that the continuity is unsatisfactory if the two signals differ significantly.

In addition to taking pairwise measurements there are other combinations that can be measured, For example—combinations of 3, 4 or more strands in each measurement.

Further, the measurements of an intact strand may be repealed for a number of times, such as 10, to eliminate temporary noise to the signal on the strand. The measurements are then combined into a statistical representation, such as mean arrival time and standard deviation a of the arrival time. If the same strand is then measured later, the continuity determined by the processor 226 is the distance from the mean in multiples of the standard deviation. In one example, the strand is later measured for 10 consecutive times and is considered faulty if the measured arrival time is outside the 3σ region for at least 9 out of 10 measurements.

In a further example, the comparison between expected, that is non-faulty, signals and unusual, that is, faulty signals is made in the frequency domain. In that case, sensor 228 or processor 226 transforms the sensed reflection signal into a frequency representation, such as by Fast Fourier Transformation. The processor stores the most significant frequency components for the non-faulty signals and compares the frequency components of the later received signals to the non-faulty frequency components. For example, the mean value of the most dominant frequency component may be 1 GHz with a standard deviation of 1 kHz. As explained before, the strand is considered faulty if the most dominant frequency component is more than 3 kHz away from the 1 GHz mean value.

In yet a further example, the processor 226 trains a statistical classifier using the non-faulty strands and later uses the sensed reflection signals to classify the respective strand as either non-faulty or faulty, which means the processor 226 determines the continuity of the strand.

FIG. 5 illustrates a method 500 for monitoring a cable. As in the previous examples, the cable comprises multiple strands which are electrically connected to each other at one or both ends of the cable and insulated from each other between the ends.

The method 500 commences with selectively activating 502 one or more inductive coils. The coils are selected as described earlier such that electrical signals are suppressed on a first set of the multiple strands and electrical signals are allowed to pass through a second set of the multiple strands.

The next step is to apply 504 an electrical stimulus signal to the cable and then to sense 506 on the cable a reflection signal of the stimulus signal. The final step is to determine 508 based on the reflection signal a continuity of one or more of the second set of the multiple strands.

It is noted that the detailed description of the system 200 in FIG. 2 comprises various details and variations, which are equally applicable to the method 500 of FIG. 5. For example, the second set of the multiple strands may comprise only a single test strand. Further, the method, may be repeated for different combination of strands in the first and second set to identify the faulty strand as explained with reference to FIG. 4. Even further, the described transformation into the frequency domain may also be part of the method.

FIG. 6 illustrates a toroidal coil 600 which may be used as one or more of the coils 216, 218, 220 and 220 in FIG. 2. Toroidal coil 600 surrounds strand 110 and comprises windings around a core 602. The core 602 may be ferrite. In other examples, the coil 600 is air-cored, with or without a non-ferrous bobbin, such as a plastic bobbin, to support the windings. The configuration of FIG. 6 facilitates retrofitting the coil 600 because coil 600, using insulated wire, can be passed around strand 110 in-situ, without the need to slacken off strand 110. In one example, the number of windings is 100, the diameter of the windings is 30 mm and the material of the windings is copper. Toroidal coil 600 is connected to selection circuit 224 which performs a described above.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may he implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the interact.

It should also be understood that, unless specifically stated otherwise as apparent from the following discussion, it is appreciated, that throughout the description, discussions utilizing, terms such as “estimating” or “processing” or “computing” or “calculating” or “generating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A method for monitoring a cable comprising multiple strands which are electrically connected to each other at one or both ends of the cable and insulated from teach other between the ends, the method comprising:
selectively activating one or more inductive coils, such that electrical signals are suppressed on a first set of the multiple strands and electrical signals are allowed to pass through a second set of the multiple strands;
applying an electrical stimulus signal to the cable;
sensing on the cable a reflection signal of the stimulus signal; and
determining based on the reflection signal a continuity of one or more of the second set of the multiple strands.

2. The method of claim 1, wherein the first set comprises all but one test strand of the multiple strands and the second set comprises the test strand.

3. The method of claim 1, wherein the electrical stimulus signal is an electrical pulse.

4. The method of claim 3, wherein the length in time of the pulse is short compared to the propagation time of the pulse along the cable.

5. The method of claims 3, wherein sensing a reflection signal comprises determining one or more arrival times of one or more pulses of the reflection signal and determining a continuity is based on the one or more arrival times.

6. The method of claim 5, wherein determining a continuity comprises comparing the one or more determined arrival times to one or more expected arrival times.

7. The method of claim 6, further comprising determining that the continuity is below a damage threshold if one of the one or more determined arrival times is earlier than one of the one or more expected arrival times.

8. The method of claim 5, wherein determining one or more arrival times comprises identifying one or more pulses reflected from a discontinuity.

9. The method of claim 1, further comprising if the determined continuity is below a damage threshold repeating the method for multiple different combinations of strands in the first set and second set, such that the multiple sensed reflection signals allow the identification of exactly one strand that has the continuity below the damage threshold.

10. The method of claim 1, wherein the first set has all but two of the multiple strands and the second set has the two of the multiple strands.

11. The method of claim 10, wherein the electrical stimulus signal is an electrical pulse and wherein determining a continuity comprises:
determining a count of one or more reflected pulses; and
determining that the continuity is below a damage threshold if the count of the one or more reflected pulses is greater than one.

12. The method of claim 1, further comprising transforming the sensed reflection signal into a frequency representation, wherein determining the continuity is based on the frequency representation of the reflection signal.

13. The method of claim 12, wherein determining the continuity comprises comparing the frequency representation of the reflected signal to an expected frequency representation.

14. A system for monitoring a cable comprising multiple strands which are electrically connected to each other at one or both ends of the cable and insulated from each other between the ends, the system comprising:
multiple coils to selectively suppress electrical signals on a first set of the multiple strands and allow electrical signals to pass through on a second set of the multiple strands;
a signal generator to apply an electrical stimulus signal to the cable;
a sensor to sense a reflection signal of the stimulus signal; and
a processor to determine based on the reflection signal a continuity of one or more of the second set of the multiple strands.
